(19) United States
(12) Patent Application Publication
(10) Pub. No.: US 2018/0002596 A1
(43) Pub. Date: Jan. 4, 2018

(54) SUBTERRANEAN FLUIDS CONTAINING SUSPENDED POLYMER BODIES

(71) Applicant: SCHLUMBERGER TECHNOLOGY CORPORATION, Sugar Land, TX (US)

(72) Inventors: Jazmin Godoy-Vargas, Missouri City, TX (US); Sergey Makarychev-Mikhailov, Richmond, TX (US); Brent Busby, Katy, TX (US); Philip Sullivan, Bellaire, TX (US); Patrice Abivin, Sugar Land, TX (US)

(21) Appl. No.: 15/544,102

(22) PCT Filed: Jan. 16, 2015
(86) PCT No.: PCT/US2015/011672

§ 371 Date: Jul. 17, 2017

(51) Int. Cl. C09K 8/88; C08J 3/24; E21B 43/04; E21B 37/06; E21B 43/26; C09K 8/80; C09K 8/68; C09K 8/52; C09K 8/512; C09K 8/12; E21B 43/267; E21B 21/00

(52) U.S. Cl. CPC C09K 8/887; E21B 43/267; C08J 3/24; E21B 43/04; E21B 37/06; E21B 21/003; C09K 8/80; C09K 8/685; C09K 8/52; C09K 8/512; C09K 8/12; E21B 43/26; C08J 2329/04; C08J 2305/08; C08J 2305/04; C08J 2305/00; C08J 2301/28; C08J 2333/14

(57) ABSTRACT

An aqueous suspension of polymer bodies is made by coalescing polymer from a flowing aqueous solution. These suspended bodies may be fibrous in appearance. However, the coalescence of the polymer bodies may be controlled to produce shapes. The coalesced polymer bodies are used for treating a downhole location within or accessed by a borehole. The bodies may be formed by coalescence at the surface and then pumped downhole or may be formed by coalescence downhole. Coalescence of polymer may result from crosslinking, complexing with material of opposite charge, or change in the polymer solution temperature, pH, solute concentration or solvent. The coalesced polymer bodies are maintained in aqueous solution after coalescence, and are not removed from solution for strengthening.

### BACKGROUND

It is long established practice to drill a borehole in order to access regions below the ground. This is commonly done in order to penetrate a hydrocarbon reservoir to extract hydrocarbons, but boreholes may also be drilled to penetrate aquifers or to penetrate other targets such as formations intended to receive carbon dioxide for storage. A variety of fluids are used in conjunction with boreholes penetrating an earth formation, in the course of drilling the borehole and also in the course of operations carried out with an existing borehole, such as fluids used in hydraulic fracturing to stimulate production from a reservoir.

The action of the fluid may take place within a borehole or in a region close to the borehole, which is sometimes termed the near wellbore region. It is also possible that fluid may be delivered through a borehole to a reservoir formation and then moved through the formation, for instance in a fluid drive when a fluid is pumped into injection wells in order to drive oil towards other wells through which the oil is produced to the surface.

Fluids used in conjunction with boreholes may be liquids or may be suspensions of solids in liquids. There are a number of instances where a fluid used in conjunction with a borehole includes suspended fibres. For example a drilling fluid may contain fibres intended to assist in plugging any fractures leading into the formation from the borehole. Fluids used in cementing of borehole casing and fluids used in stimulation treatments of existing wells may also include fibres. Fibres may assisted in suspending other solids in a fluid and/or may assist in placing other solids where required downhole.

Fibres are usually manufactured and then packaged as dried fibres to be transported to a well site and added to fluid at the well site. The resultant shipping, handling, storage, unpacking and addition to fluid becomes a significant amount of work when fibres are used in large quantities.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth.

In a first aspect, embodiments of the present disclosure provide a method of treating a borehole or a downhole location accessed through the borehole, the method comprising coalescing polymer from a polymer solution to generate an aqueous suspension of bodies of polymer and providing the bodies at a downhole location within or outside the borehole, while keeping the bodies in aqueous suspension.

Thus, in contrast with a previous approach in which fibres are manufactured as a dry product, transported to a well site and then added to fluid, embodiments of the present disclosure form bodies of polymer as a suspension in fluid and the bodies stay in the suspension until they arrive at the subterranean location where they are required. Thus, in use, the bodies are not isolated from all suspending liquid, although it is possible that the suspension may be diluted after the bodies have been formed or conversely may be concentrated by removing some liquid after the bodies have been formed. In embodiments of the present disclosure, the suspended bodies are large enough to be seen by the human eye, either unaided or with some optical magnification.

The bodies of the present disclosure may have lower strength than fibres which have been isolated and dried after fibre formation, but, surprisingly, it has found that the fibres nevertheless have properties that are useful for downhole applications.

In embodiments of the present disclosure, the polymer solution from which the polymer is coalesced may be aqueous. The polymer solution may be in motion, for example flowing, as the coalescence takes place. Motion of the solution may promote the formation of extended bodies of polymer rather than a uniform precipitate of polymer particles. Polymer bodies may be elongate, extending over lengths which are greater than any widths transverse to the length. Thus the coalesced bodies may be akin to fibres or ribbons. In other embodiments, flow techniques may be used to produce other shapes of polymer structures, such as discs, spheres, tubes and/or the like.

There are a number of possible methods for bringing about coalescence of the polymer, as is explained below. A number of these involve mixing the polymer solution with a second solution to bring about the coalescence, where the second solution may contain a material which is able to induce coalescence. In some embodiments, the second solution may also comprise an aqueous solution. Consequently, in some embodiments, the aqueous suspension of polymer bodies may contain little or no non-aqueous solvent.

In another aspect, some embodiments of the present disclosure may also include an aqueous suspension of bodies of a polymer obtained or obtainable by coalescence from the solution of the first aspect.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 is a diagram of laboratory-scale apparatus for coalescing polymer structures;

FIG. 2 shows an arrangement with concentric tubes, used to form polymer bodies, in accordance with embodiments of the present disclosure;

FIG. 3 shows apparatus for production of suspended polymer bodies at the surface, prior to pumping downhole, in accordance with embodiments of the present disclosure;

FIGS. 4 and 5 show two mixing arrangements for possible use in the apparatus of FIG. 3;

FIG. 6A is an image of the elongated coalesced polymer bodies, produced in accordance with embodiments of the present disclosure, obtained from precipitation of guar with isopropanol in Example 1, and FIG. 6B is a magnified image of these elongated bodies;

FIG. 7A is an image of the coalesced polymer bodies obtained in accordance with embodiments of the present disclosure from precipitation of chitosan with sodium hydroxide, using chitosan #1 in Example 5, and FIG. 7B is a magnified image of these bodies;

FIGS. 8A and 8B are corresponding images for the intermediate molecular weight chitosan#2 used in Example 5;

FIGS. 9A and 9B are corresponding images for the higher molecular weight chitosan#3 used in Example 5;

FIG. 10 is a graph showing the extent of setting of a bed of proppant particles, as described in Example 6;

FIG. 11A is an image of the coalesced polymer bodies obtained in accordance with embodiments of the present disclosure from hydroxypropylcellulose on addition to hot water in Example 9, and FIG. 11B is a magnified image of these bodies;

FIG. 12 is an image of the coalesced polymer bodies obtained in accordance with embodiments of the present disclosure by adding aluminium chloride solution to carboxymethylcellulose solution in Example 10;

FIG. 13 is an image of the coalesced polymer bodies obtained in accordance with embodiments of the present disclosure by adding carboxymethylcellulose solution to aluminium chloride solution, also in Example 10;

FIG. 14 is an image of the coalesced polymer bodies obtained in accordance with embodiments of the present disclosure by adding sodium alginate solution to calcium chloride solution, in Example 13;

FIG. 15 is an image of ribbon-like coalesced polymer bodies obtained in accordance with embodiments of the present disclosure from chitosan and sodium dodecyl sulphate solutions in Example 15;

FIG. 16 and FIG. 17 are magnified images of coalesced polymer bodies obtained in accordance with embodiments of the present disclosure enclosing solid particles of other material;

FIGS. 18A, 18B and 18C are magnified images of suspended bodies of polymer complex formed in accordance with embodiments of the present disclosure under three different stirring regimes in Example 16;

FIG. 19 is a magnified image of coalesced polymer bodies formed in accordance with embodiments of the present disclosure by co-annular flows containing ADBAC and CMC;

FIG. 20 is a magnified image of coalesced polymer bodies formed in accordance with embodiments of the present disclosure by co-annular flows containing ADBAC and CMC in KCl solutions;

FIG. 21 shows an apparatus for making polymer bodies of controlled length by means of co-annular flows, in accordance with embodiments of the present disclosure;

FIG. 22 is a plot of stress/strain curves for alginate fibres;

FIG. 23 is a plot of stress/strain curves for chitosan fibres; and

FIG. 24. shows settling of proppant over time, in the presence of alginate fibers, as in Example 22.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In some embodiments of the present disclosure, polymer which is initially in aqueous solution is made to coalesce so as to form a suspension of bodies/structures of the polymer. The aqueous solution may be homogenous before coalescence takes place. Coalescing the polymer brings amounts of the polymer together, thus reducing concentration of polymer in the solution. The solution, thus becomes a heterogenous suspension of the bodies that have been formed.

Coalescence of polymer may be performed at the surface, after which the suspension of coalesced polymer bodies is pumped or otherwise cause to travel downhole. Alternatively, the coalescence may be made to occur at a location downhole, using polymer solution supplied from the surface. This downhole location could be at or close to the subterranean location, which is the intended destination of the suspended bodies, so that the bodies may not travel very far while underground, or could be at some point between the surface and the intended destination so that the bodies do travel below ground after they are formed.

In some embodiments, bodies of polymer in aqueous suspension are formed by coalescence at the surface and are then made to pass through a pump which is pumping fluid downhole. Such a pump may also be at the surface. Surprisingly, it has been found that although the suspended bodies according to embodiments of the present disclosure are not as strong as the pre-manufactured fibres, which have been isolated and dried during manufacture, the bodies are not destroyed or formed into an amalgam or the like when passed through a pump and pumped down a borehole.

In other embodiments, the polymer solution may be delivered through a pump into the borehole and the bodies/structures/fibres may be formed underground by coalescence of polymer from the polymer solution. It some embodiments, the coalescence to form polymer bodies downhole may take place after the polymer solution has passed through a downhole screen or through a downhole tool, which may be cutting tool such as a reamer, a drill bit or the like. Such embodiments are advantageous in that where the formation of polymer bodies occurs downhole, unlike adding previously manufactured fibres at the surface, the risk of the fibres/bodies/structures clogging pathways through the downhole screen, downhole tools of the like is eliminated.

Polymer

In some embodiments, the polymer that coalesces to form the suspended bodies may be a single polymer or a mixture of polymers. For example, an individual polymer may be a monodisperse polymer or a polydisperse polymer.

The polymer may have any desired molecular weight. For example, a polymer may have a weight average molecular weight greater than about 5,000 Daltons, possibly at least 10,000 Daltons and possibly up to 2,000,000 Daltons, or more such as up to about 20,000,000 Daltons or more.

The polymer may be selected from natural polymers, synthetic polymers, or biopolymers (or derivatives thereof) or mixtures thereof that comprise a crosslinkable moiety, for example, substituted galactomannans, guar gums, high-molecular weight polysaccharides composed of mannose and galactose sugars, or guar derivatives, such as hydrophobically modified guars, guar-containing compounds, and synthetic polymers. Suitable polymer chemical entities may comprise a guar gum, a locust bean gum, a tara gum, a honey locust gum, a tamarind gum, a karaya gum, an arabic gum, a ghatti gum, a tragacanth gum, a carrageenen, a succinoglycan, a xanthan, a diutan, scleroglucan, alginates, a hydroxylethyl guar, a hydroxypropyl guar (HPG), a carboxymethylhydroxyethyl guar, a carboxymethylhydroxypropyl guar (CMHPG), a carboxyalkyl cellulose, such as carboxymethyl cellulose (CMC) or carboxyethyl cellulose, an alkylcarboxyalkyl cellulose, an alkyl cellulose, an alkylhydroxyalkyl cellulose, a carboxyalkyl cellulose ether, a hydroxyethylcellulose (HEC), hydroxypropylcellulose (HPC), a carboxymethylhydroxyethyl cellulose (CMHEC), a carboxymethyl starch, a copolymer of 2-acrylamido-2methyl-propane sulfonic acid and acrylamide, a terpolymer of 2-acrylamido-2methyl-propane sulfonic acid, acrylic acid, acrylamide, or derivative thereof. The polymer may also be a synthetic polymer such as, for example, a polyacrylamide including partially hydrolyzed polyacrylamide (PHPA); polyvinyl alcohol; polyethylene glycol; polypropylene glycol; polyacrylic acid or polymethacrylic acid; as well as copolymers and mixtures thereof.

In some embodiments, a polymer which is one of guar, cellulose, xanthan, diutan, alginate or a derivatives of one of these polymers may be used.

In some embodiments, a polymer may be functionalized, such as hydrophobically modified to inhibit or delay solubilization and/or precipitation. For example, where the polymer includes a polyol, the polyol may be hydrophobically modified by including hydrocarbyl substituents, such as, for example, alkyl, aryl, alkaryl or aralkyl moieties and/or side chains having from about 2 to about 30 carbon atoms, or about 4 to about 20 carbon atoms.

The polymer may be modified to include carboxylic acid groups, thiol groups, paraffin groups, silane groups, sulphuric acid groups, acetoacetylate groups, polyethylene oxide groups, and/or quaternary amine groups. In some embodiments of the present disclosure, the concentration of polymer in the polymer solution may lie in a range from 0.1 wt % to 10 wt %. The concentration may be at least 0.2 wt % or at least 0.5 wt % and possibly at least 1 wt %. The concentration may possibly not exceed 5 wt % or 3 wt %. These ranges of percentages by weight may also apply to the concentration of polymer bodies in the suspension that is formed when coalescence takes place.

In some embodiments, the polymer may increase the viscosity of the polymer solution relative to the viscosity of water. Consequently the polymer solution may have a viscosity in a range from about 5 cP (5 mPa·s) to about 10,000 cP (10 Pa·s). This viscosity range may possibly be from about 10 cP (10 mPa·s) upwards and possibly may be up to about 1000 cP (1 Pa·s) or up to about 100 cP (100 mPa·s).

Coalescence

In some embodiments of the present disclosure, coalescence of polymer to form suspended bodies of polymer comprises the bringing together of polymer that was previously distributed as part of the polymer solution. Since the polymer is no longer in solution as before and becomes visible, this action may be regarded as a form of precipitation although the precipitated polymer may not be a true solid and for instance may be in the form of an amorphous gel.

Coalescence of polymer to form suspended bodies may be brought about in a number of ways. The method that is chosen may depend upon whether it is carried out downhole or at the surface. There may also be choice of method and choice of polymer in relation to each other because some methods make use of specific polymer characteristics.

Some methods of coalescing polymer may be listed as changing features of the solution, which is the polymer environment: these environmental changes may comprise change of the solvent itself or change in solution properties such as pH or ionic concentration and/or the like. For some polymers, coalescence may be brought about by a change in temperature of the polymer solution. Further methods of coalescing polymer involve connecting polymer molecules together by cross-linking or complexing polymer molecules with other molecules. These various possibilities will be discussed in turn.

Change of solvent to precipitate polymer may comprise mixing the polymer solution with a second liquid, which is not a solvent for the polymer, but is soluble in the solvent of the polymer solution. One example is adding an organic alcohol to an aqueous polymer solution with the consequence that the polymer precipitates from the mixed aqueous alcohol solution.

Polymers suitable for solvent change precipitation may be synthetic or naturally-occurring. Some examples of polymer classes include polysaccharides and their derivatives, polyamides, polyethers, polyesters and polyolefins. Examples of solvents for such polymers include various alcohols such as methanol, ethanol, and isopropanol, and other organic water-miscible solvents mentioned above. For example, isopropanol-water is a suitable solvent pair to precipitate guar from a water solution. Addition of isopropanol to achieve a ratio of about 1:5 isopropanol:water is suitable to bring about precipitation of guar from aqueous solution.

In some embodiments, coalescence of polymer can be brought about by changing the pH of a solution of a polymer whose solubility is pH dependant. Such a polymer may have ionisable groups such as carboxylic acid groups or amino groups so that ionisation increases solubility in aqueous solution. In such embodiments, the formation of the extended bodies may be induced by mixing with an additive that adjusts the pH of the solution or by mixing with a second solution having a different pH.

Examples of pH-sensitive polymers are alginate, chitosan, cellulose acetate phthalate, cellulose acetate trimellitate, hydroxypropylmethylcellulose phthalate, polyacrylic acid, poly(methyl methacrylate) copolymers, and shellac. Other polymer classes may be mixed with a pH-sensitive polymer, examples include neutral polysaccharides, polyethers, polyacetals, polyamides and polyesters.

Additives for control of pH may include sodium, potassium and ammonium sesquicarbonates, oxalates, carbonates, hydroxides, bicarbonates, acids and organic carboxylates such as acetates and polyacetates. Examples are sodium sesquicarbonate, sodium carbonate, and sodium hydroxide. Soluble oxides, including slowly soluble oxides such as MgO, may also be used. Amines and oligomeric amines, such as alkyl amines, hydroxyalkyl amines, anilines, pyridines, pyrimidines, quinolines, and pyrrolidines for example triethanolamine and tetraethylenepentamine, may also be used.

In some embodiments, reversing the change in pH, i.e. subsequently returning the pH of the suspension towards its initial value will redissolve the polymer, and therefore disrupt the suspended bodies.

A salinity change to cause coalescence of polymer into suspended bodies may comprise mixing the polymer solution with a second liquid to change the ionic concentration. There are two opposite scenarios where a change in salinity can induce the formation of the suspended bodies. The first is the use of a polymer that is soluble in low saline solvents, which polymer precipitates with an increase in salinity. In the other, the polymer is soluble in high salinity water/solvent and the polymer can be made insoluble by mixing with water/solvent of low or zero salinity.

Polymers suitable for precipitation by a change in ionic concentration (solvent salinity change precipitation), may be synthetic or naturally-occurring.

Polyvinyl alcohol (PVA) is an example of a polymer which can be dissolved initially in fresh water (or low salinity), but will precipitate out of solution when mixed with a high salinity fluid. The opposite is true of poly(2-hydroxyethylmethacrylate) (polyHEMA), which is soluble in water with high salt levels, such as zinc bromide/calcium bromide brines, but is insoluble in water with low salt levels.

A further method of inducing coalescence of polymer is by means of temperature change. Many polymers show an increase in solubility with the temperature of the solvent. However, there are some polymers which exhibit a Lower Critical Solution Temperature (LCST) also referred as the cloud point, which is a temperature above which they become insoluble. LCST polymers are soluble at temperatures below the LCST, but as the temperature increases the polymer-polymer interactions overcome the solvent-polymer interactions, rendering the polymer hydrophobic. Dissolved polymer begins to come out of solution at the LCST, giving some opacity. A further temperature increase leads to complete precipitation of the polymer.

Some examples of LCST polymers include poly(N-isopropylacrylamide), poly(methyl vinyl ether), hydroxypropyl cellulose, poly(ethylene glycol), poly(vinyl caprolactam), and their copolymers.

Increase in temperature may take place as a polymer solution is carried downhole, or it may be brought about at the surface, such as by heating the polymer solution, and/or by mixing the polymer solution with another fluid which is at a higher temperature.

Crosslinking

In some embodiments, a somewhat different approach to causing coalescence of polymer and the formation of suspended bodies is used to bring about cross linking of the polymer using a compound that forms cross links between polymer molecules. This leads to an increase in molecular weight, with the result that the cross-linked polymer precipitates. The precipitate after cross linking may be a polymer gel.

Cross-linkable polymers may include synthetic and/or naturally occurring polymers or polyelectrolytes capable of dispersing in an aqueous or organic solvent solution (such as those mentioned above and throughout the present specification) that can undergo a crosslinking reaction with the introduction of a crosslinking agent. Suitable polymers may also include polysaccharides such as galactomannans which are high-molecular weight polysaccharides composed of mannose and galactose sugars. Guar is a galactomannan as are guar derivatives such as hydroxypropyl guar (HPG), carboxymethylhydroxypropyl guar (CMHPG) and carboxymethyl guar (CMG).

Other suitable classes of water-soluble polymers include polyvinyl polymers, polymethacrylamides, cellulose ethers, lignosulfonates, and their ammonium, alkali metal, and alkaline earth salts thereof. Further examples of other suitable water soluble polymers include acrylic acid-acrylamide copolymers, acrylic acid-methacrylamide copolymers, polyacrylamides, partially hydrolysed polyacrylamides, partially hydrolyzed polymethacrylamides, polyvinyl alcohol, polyalkyleneoxides, other galactomannans, heteropolysaccharides obtained by the fermentation of starch-derived sugar and their ammonium and alkali metal salts thereof. Suitable examples of biopolymers include gellan, carrageenans, sodium alginate, gelatin, agar, agarose, maltodextrin, chitosan, and combinations thereof. Additional examples of biopolymers are described in U.S. Pat. No. 5,726,138, U.S. Pat. No. 7,169,427, and United States Patent Publication no. 2005/0042192.

Cellulose derivatives such as hydroxyethylcellulose (HEC) or hydroxypropylcellulose (HPC), carboxymethylhydroxyethylcellulose (CMHEC) and carboxymethylcellulose (CMC) are further instances of water-soluble polymers which may be crosslinked in accordance with some embodiments of the present invention.

A “cross-linking agent” refers, for example, to a compound or mixture that assists in the formation of a three-dimensional polymerized structure of the one or more polymers. A variety of crosslinkers may be used in accordance with embodiments of the present disclosure, for example, organic crosslinkers, inorganic crosslinkers, divalent metals, trivalent metals, and polyvalent metals, such as calcium, iron, chromium, copper, boron, titanium, zirconium, aluminium and the like. Suitable boron crosslinked polymers systems include guar and substituted guars crosslinked with boric acid, sodium tetraborate, and encapsulated borates; borate crosslinkers may be used with buffers and pH control agents such as sodium hydroxide, magnesium oxide, sodium sesquicarbonate, and sodium carbonate, amines (such as hydroxyalkyl amines, anilines, pyridines, pyrimidines, quinolines, and pyrrolidines, and carboxylates such as acetates and oxalates) and with delay agents such as sorbitol, aldehydes, and sodium gluconate. Suitable zirconium crosslinked polymer systems include those crosslinked by zirconium lactates (for example sodium zirconium lactate), triethanolamines, 2,2-iminodiethanol, and with mixtures of these ligands, including when adjusted with bicarbonate. Suitable titanates include lactates and triethanolamines, and mixtures, for example delayed with hydroxyacetic acid.

The amount of crosslinker may be such that, if there was no crosslinking and precipitation, the concentration of crosslinker in the polymer solution would be from about 0.001 wt % to about 10 wt %, such as at least 0.005 wt % or at least 0.01 wt % up to 2 wt % or 1 wt %.

In some embodiments, a solution of a crosslinkable polymer is mixed with a crosslinking agent or a solution of crosslinking agent and coalescence of polymer then takes place. In other embodiments, the polymer solution contains both crosslinkable polymer and a crosslinking agent, but these do not react until crosslinking is triggered by a further event such as a pH change.

A further approach for coalescing polymer, according to embodiments of the present disclosure utilises a polymer which is ionically charged and forms a complex between this polymer and an entity of opposite charge. The complex (which is of higher molecular weight than the polymer) comes out of solution. The entity of opposite charge may be an oppositely charged polymer or may be an ionic surfactant.

One charged polymer which may be used is chitosan. Chitosan which is an amino-containing biopolymer derived from chitin, one of the components of crustacean and insect shells. It has a structure:

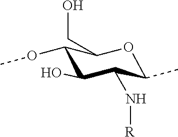

where: R denotes acetyl or hydrogen and hydrogen is more frequent than acetyl. The amino groups can be protonated so that the polymer carries a positive charge. Chitosan can form a complex with a polymer having negative charge, such as xanthan which contains residues of glucuronic acid as well as residues of glucose and mannose. Chitosan can also form a complex with a surfactant that incorporates a carboxylic or sulphonic acid group, as is the case for many anionic surfactants.

It will be appreciated that a number of these methods may be implemented by mixing two solutions and in some instances the polymer solution and the solutionthat it is mixed with are both aqueous solutions. For example, an aqueous polymer solution may be mixed with an aqueous solution to change pH, or an aqueous polymer solution may be mixed with an aqueous solution of a cross linking agent, or an aqueous solution of polymer with ionic charge may be mixed with an aqueous solution of a polymer or surfactant of opposite ionic charge. If coalescence is brought about by mixing two aqueous solutions, the resulting suspension of coalesced polymer bodies may contain little or no non-aqueous solvent. Possibly, the amount of non-aqueous solvent in that suspension is not more than 10 wt %, perhaps not more than 5 wt % or 2 wt %.

All of the methods for coalescence of polymer in accordance with embodiments of the present disclosure may be carried out at the surface of the Earth, such as at a well site, or may be carried out downhole. In order to bring about coalescence below ground, in some embodiments of the present disclosure a technique to avoid coalescence taking place prematurely may be used. One such technique comprises using an LCST polymer and on exposing the LCST polymer to underground temperature to bring about coalescence. Temperatures below ground are frequently found to be higher than temperatures at the surface.

Where coalescence is induced by mixing materials, one material may be conveyed downhole separately from another by separate flow paths within a wellbore. This can for instance be achieved by using coiled tubing within a wellbore to deliver one material, while using the annulus around the coiled tubing as the flow path for another material. As an example, in some embodiments, a polymer solution is pumped through coiled tubing, while an agent to change the pH is pumped through the annulus around the coiled tubing. If coalescence of polymer is brought about by formation of complex between two polymers such as between chitosan and xanthan, a solution of one polymer may be pumped down the coiled tubing and a solution of another polymer may be pumped down the annulus outside the coiled tubing. Concentric coiled tubing having an inner tube and an outer tube may be used in a similar fashion. The inner tube can then serve as one conduit and the annulus formed between the inner tube and the outer tube can then serve as the second conduit.

Where coalescence results from mixing materials, another method to delay coalescence until the polymer solution is sufficiently downhole is to encapsulate one material so that it is released below ground. For instance, an acidic solution containing chitoson may be pumped into a well while carrying suspended particles consisting of sodium carbonate encapsulated in a wax that melts when exposed to downhole temperature and then raises the pH of the solution. A similar approach may be used where coalescence of polymer is brought about by formation of complex between a polymer and a surfactant of opposite charge. The surfactant may be provided as particles coated with a material which is a solid at surface temperature but which melts at reservoir temperature.

Formation of suspended bodies through coalescence of polymer may be carried out while the polymer solution is flowing. Movement of the liquid may assist the formation of bodies which are of elongate shape. Flow of liquid can create shear deformation in the solution and this may assist the formation of bodies which are elongate.

Coalescence of polymer may take place in a variety of forms of apparatus and the flow of the polymer solution may occur as the solution is made to flow through a pump, mixer or pipework or is flowing within a wellbore or reservoir. In some embodiments, the coalescence of polymer is induced by mixing of liquids, one liquid may be directed into the other through nozzle(s) or other orifice(s) to give speed or direction to the flow or to increase the magnitude of shear. In some embodiments, the flow into the other liquid may be controlled to produce different polymer structures/shapes.

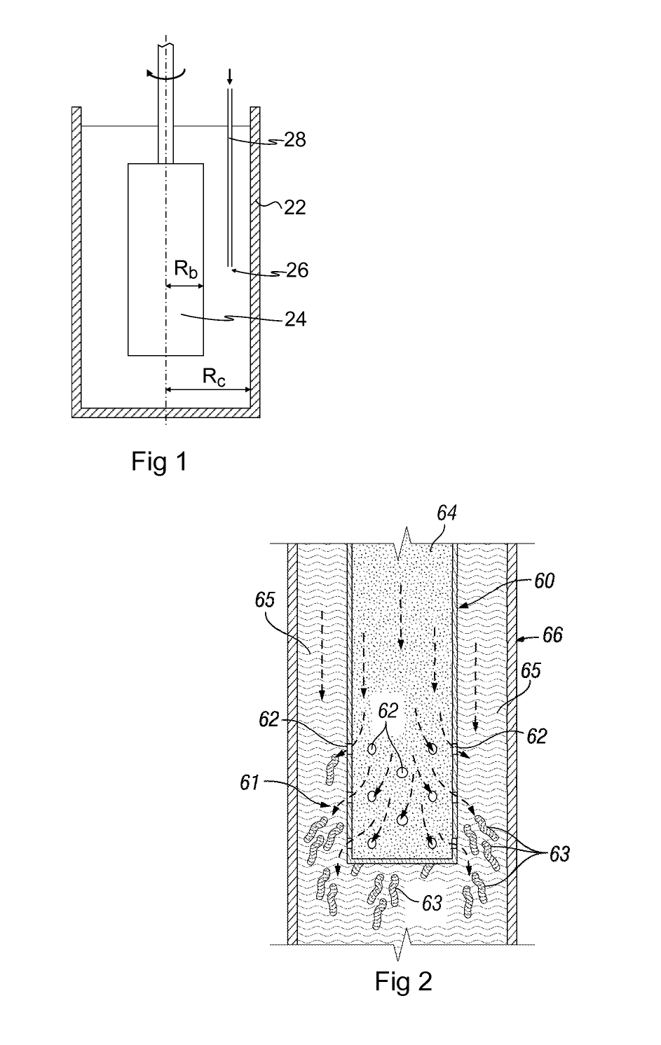

FIG. 1 shows a form of apparatus that may be used on a laboratory scale for mixing two liquids, one of which is the polymer solution. A plastic beaker 22 is used to hold one liquid. A solid cylinder 24 attached to an overhead motor (not shown) extends into the beaker 22 from above, so that the cylinder 24 is coaxial with the beaker 22. When liquid is placed in the beaker and the motor is run, the liquid is stirred, in that it is made to flow around in the annulus between the cylinder 24 and the side wall of the beaker 22. The liquid is thus subjected to shear between the moving cylinder and the side of the beaker. A second liquid is then added to the moving liquid at the point 26 half way between the cylinder and the side of the beaker. For the purpose of illustration, FIG. 1 shows a tube 28 for the supply of the second liquid to point 26, but addition at point 26 may conveniently be done using a syringe or syringe pump.

On a larger scale, in accordance with embodiments of the present disclosure, a pumping apparatus (positioned either at the surface of the wellbore or down hole) is used in connection with conduits having a perforated portion, such as, for example, a pipe with a perforated end, coiled tubing having a perforated end portion or a pipe with one or more nozzles.

FIG. 2 illustrates an arrangement, in accordance with embodiments of the present disclosure, in which mixing of liquids and formation of elongate bodies of polymer takes place within a pipe. An inner pipe 60 has a perforated end 61 comprising a plurality of openings 62. A polymer solution 64 is supplied along the inner pipe 60 while a second liquid 65 is supplied along the annulus between the inner pipe 60 and the outer pipe 66. Polymer from the solution 64 coalesces into elongate bodies as the solution 64 flows out through the openings 62 into the liquid 65. Alternatively, polymer solution may be delivered along the annulus between the inner and outer pipes while a second liquid to induce coalescence of polymer is delivered along the inner pipe 60. This apparatus may be used on the surface at a well site or the outer pipe 66 could be tubing of a borehole while the inner pipe 60 is coiled tubing inserted into the borehole. Flow rates of the polymer solution and the second liquid which induces coalescence may in a range of from about 10 liters per minute (L/min) to about 20000 liters per minute, such as from about 80 liters per minute to about 16000 liters per minute, or from about 800 liters per minute to about 12000 liters per minute.

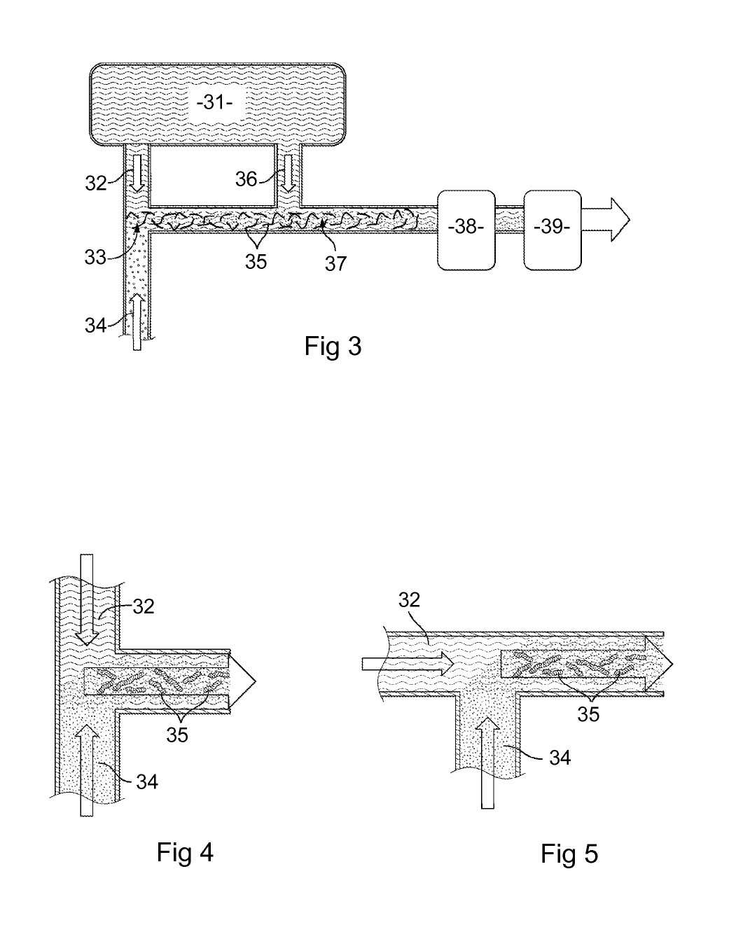

As discussed above, in some embodiments of the present disclosure, the coalesced polymer bodies may be formed on the surface in the vicinity of the wellhead and subsequently placed into the subterranean formation. An example process for the surface creation of the coalesced polymer bodies in accordance with embodiments of the present disclosure, is illustrated in FIG. 3. In FIG. 3, a polymer is mixed with water in a tank or a continuous mix hydration device 31, such as, a precision-continuous mix (PCM) unit. All or a portion of the polymer solution may then be sent via a first stream 32 to a mixing arrangement 33. At the mixing arrangement 33, the first stream 32 is mixed with a second liquid 34 (which may possibly be a solution of surfactant or second polymer) to create coalesced polymer bodies 35 suspended in the fluid. One possibility is that the polymer in device 31 is carboxymethylcellulose (CMC) and the second liquid 34 is a solution of a cationic surfactant or second polymer to complex with the CMC.

Once formed, the coalesced polymer bodies 35 may be combined with additional polymer solution 36 to increase the fluid viscosity. The resulting suspension of coalesced polymer bodies 37 in a viscous fluid may then be delivered to a blending device 38, such as a POD blender, as described in U.S. Pat. Nos. 4,453,829, 4,671,665, 4,614,435, 4,838,701, 4,808,004, 5,046,856, 5,667,012, 7,845,516 and 7,740,447, and U.S. Patent Application Pub. Nos. 2008/0212397, 2011/0235460 and 2012/0298210, the disclosures of which are incorporated by reference herein in their entirety for all purposes, where sand or proppant can be added to the fluid. After this, the mixed fluid may then be delivered through high pressure pumps 39 to the wellhead (not shown) for flow downhole into the subterranean formation.

There are various possibilities for the mixing arrangement 33. FIG. 4 illustrates an impinging tee, where streams 32 and 34 mix to form coalesced polymer bodies 35. FIG. 5 illustrates a side stream injection in a tubular, where streams 32 and 34 combine to form coalesced polymer bodies 35. In some embodiments of the present disclosure, the mixing arrangement may be as shown in FIG. 2, utilizing a pipe with a perforated end portion to deliver one liquid into another, inducing coalescence of polymer as the liquids mix.

In a variation to the process shown in FIG. 3, the second liquid which is mixed with the first stream 32 contains both a material to induce coalescence of the polymer in the first stream and also a second polymer serving to raise the viscosity of the suspension of coalesced polymer bodies which is formed upon mixing.

Properties

Bodies of polymer in aqueous suspension, formed by coalescence of polymer from solution in accordance with embodiments of the present disclosure, may be large enough to be seen by eye when suspended in an aqueous liquid. One or more dimensions may be at least 0.1 mm, possibly at least 0.5 mm. Bodies of suspended polymer may have a variety of shapes. Some bodies which are formed in accordance with this invention are elongate, having a length:width ratio (so-called aspect ratio) of 3:1 or more, and some forms of body have extended length so that aspect ratio is at least 6:1, possibly at least 10:1, possibly 50:1 or more.

The bodies of polymer in accordance with embodiments of the present disclosure, have a strength which is of the order of less than that of commercially produced fibres which have been isolated and dried as part of the manufacturing process. Nevertheless, surprisingly it has been found that the bodies have strength and can for example remain intact if lifted out of the suspension and handled gently. In some embodiments of the present disclosure, the suspended bodies may have an ultimate tensile strength which is less than 1000 kPa. Surprisingly, bodies in accordance with embodiments of the present disclosure with a fibrous form can be used in a manner akin to the use of stronger fibres which are supplied as a dried product.

There are a variety of applications in which fluids containing bodies of coalesced polymer may be used. Thus the suspension of coalesced polymer bodies may be used as, or incorporated in: a drilling fluid, a drill-in fluid (which is used as a drilling fluid when drilling within a reservoir) a fracturing fluid, a gravel packing fluid, a fluid loss control pill, a water control treatment fluid, a scale inhibition treatment fluid, a cement slurry, or a completion fluid. Examples of some of these materials are described in U.S. Pat. No. 5,330,005, U.S. Pat. No. 5,439,055; U.S. Pat. No. 5,501,275; U.S. Pat. No. 6,172,011; and U.S. Pat. No. 6,419,019. Furthermore, any additives normally used in such treatments may be included, provided that they are compatible with the other components and the desired results of the treatment. Such additives may include anti-oxidants, crosslinkers, corrosion inhibitors, delay agents, biocides, buffers, fluid loss additives, and so on.

A method as stated above may include the following actions, in any order: placing an aqueous flow, such as a treatment fluid, injecting a polymer into a subterranean formation via a wellbore, and generating an aqueous suspension of coalesced bodies of a polymer from an aqueous flow containing the polymer.

Coalesced bodies of polymer, in accordance with embodiments of the present disclosure, may assist the suspension of particulate solids (other than the polymer) in the fluid. This function of coalesced polymer bodies may be utilised in various fluids including hydraulic fracturing fluids where there is a need to suspend proppant particles as the fluid is conveyed towards and into a hydraulic fracture.

One form of embodiments of the present disclosure provides a method of hydraulic fracturing of a subterranean formation, including a preliminary step of injecting a treatment fluid into a formation adjacent a wellbore in the subterranean formation at a pressure sufficient to create a fracture (with opposing faces) in the formation, followed by a step of injecting a fracturing fluid which contains suspended polymer bodies formed by coalescence of polymer as above.

Coalesced bodies, in accordance with embodiments of the present disclosure, may assist in bridging and blocking openings where these are not desired. Such bodies may therefore be used in fluids for counteracting loss of drilling fluid into fractures in the formation around a borehole. The bodies could be used in drilling fluid itself or in fluid which is added in small quantity (a so-called “pill”) as a countermeasure when fluid loss is encountered.

Coalesced polymer bodies may also be used in so-called diversion fluids u8sed within a reservoir to divert a treatment fluid away from treated regions to regions which have yet to be treated.

In some applications it can be acceptable and indeed at times useful if the coalesced polymer bodies have a limited life. For example if coalesced polymer bodies are used to assist the placing of proppant within a hydraulic fracture, the coalesced polymer is no longer required once the proppant is in place. The polymer of the coalesced bodies may, for such an application, be a polymer which chemically degrades over time. An example of such a polymer is polylactic acid which, over time, undergoes hydrolysis of its ester linkages. So, some forms of this invention comprise a subsequent step of degrading the polymer bodies after providing them at the downhole location.

Fluids containing coalesced polymer bodies, in accordance with embodiments of the present disclosure, may contain further materials, depending on their intended function. In some embodiments of the present disclosure, the fluids may contain other polymers as thickeners and/or may contain salts. The fluids may include other fibrous material, which may be organic fibres, inorganic fibres, mixtures thereof and combinations thereof. Such fibres may act as seeds for the precipitation of the in situ formed precipitates. For example, the coalesced polymer bodies that form in the fluids described may form on and/or around seed particles (including, for example, proppants) and/or fibres.

Stabilizing agents may be added to the fluid to slow any degradation of the coalesced polymer bodies after formation. Stabilizing agents may include buffering agents, such as agents capable of buffering at pH of about 8.0 or greater (such as water-soluble bicarbonate salts, carbonate salts, phosphate salts, or mixtures thereof, among others); and chelating agents (such as ethylenediaminetetraacetic acid (EDTA), nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others). Buffering agents may be present in the treatment fluid in an amount of at least about 0.05 wt %, such as from about 0.05 wt % to about 10 wt %, and from about 0.1 wt % to about 2 wt %, based upon the total weight of the treatment fluid. Chelating agents may be added to the treatment fluid in an amount of at least about 0.75 mole per mole of metal ions expected to be encountered in the downhole environment, such as at least about 0.9 mole per mole of metal ions, based upon the total weight of the treatment fluid.

### Example 1 Precipitation by Adding Non-Solvent

A solution of guar gum (0.36 wt %) was prepared by dissolving the polymer in distilled water while stirring the mixture for 30 minutes at approximately 1500 rpm in a laboratory blender. Next, the guar solution was transferred to a plastic beaker and stirred with a central cylinder as in FIG. 1 rotated at 1000 rpm (submitting the fluid to shear rates between 150 to 300 s⁻¹). Isopropanol was added by means of a syringe pump to reach a final concentration of 28 wt % isopropanol. This stirring of the mixture was continued for another two minutes at 1000 rpm following the addition of isopropanol.

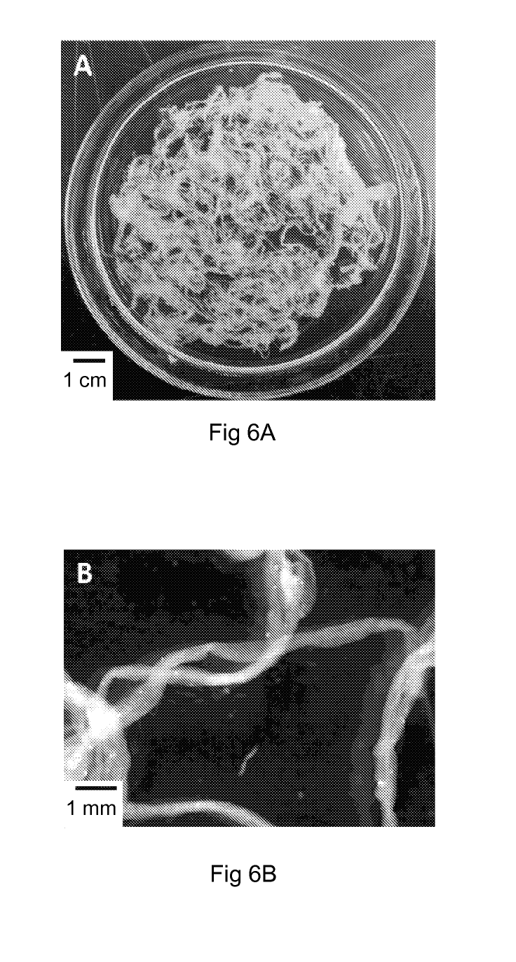

Guar precipitated, forming a tangled mass of white elongated fibre-like bodies which were observed (using a stereo microscope) to have lengths of more than 5 cm and a slightly varying diameter of about 1 mm, as illustrated in FIG. 6A, which is an image of the elongated precipitates obtained from precipitation of guar with isopropanol, and FIG. 6B, which is an enlarged image of the elongated precipitates, obtained using a stereo microscope.

Similar results were obtained when the guar solution was replaced with a 1 wt % solution of carboxymethylcellulose (CMC) or a 1 wt % solution of hydroxymethylpropyl guar (HMPG).

### Example 2

A solution of guar gum (0.54 wt %) was prepared by dissolving the polymer in distilled water while stirring the mixture for 30 minutes at approximately 1500 rpm in a laboratory blender. Then potassium chloride was added to obtain a concentration of 4% KCl in the guar solution. The mixture was stirred for another 15 minutes in the blender and then transferred to a plastic beaker with a central cylinder as in FIG. 1. While rotating the cylinder at 1000 rpm using an overhead motor, methanol was added with a syringe pump to reach a final concentration of 28 wt % methanol. The mixture was stirred in this way for another two minutes at 1000 rpm (submitting the fluid to shear rates between 150 to 300 s⁻¹) following the addition of methanol.

Once again guar precipitated as white elongated fibre-like bodies with lengths exceeding 5 cm and width of about 1 mm.

### Example 3 Precipitation by Adding to Non-Solvent

A sodium alginate solution (1.5 wt %) (Sigma Aldrich, alginic acid sodium salt from brown seaweeds) was prepared by adding the polymer powder to distilled water and stirring the mixture for 30 minutes at approximately 1,500 rpm in a laboratory blender. Separately, 50 mL of ethylene glycol butyl ether (Sigma Aldrich) was placed in a plastic beaker provided with a rotatable central cylinder as in FIG. 1. While stirring the ethylene glycol butyl ether by rotating the cylinder at 1,000 rpm using an overhead motor, 10 mL of the alginate solution was added using a syringe pump. Stirring of the mixture was continued for 2 minutes at 1,000 rpm following the addition of alginate. The alginate precipitated forming long, white fibre-like bodies with widths which varied but were generally between 0.3 and 1.5 mm and lengths exceeding 10 cm.

### Example 4

A 1.0 wt % sodium alginate solution was prepared as in Example 3 above. Isopropanol was placed in a plastic beaker and stirred by rotating a central cylinder as in FIG. 1. The alginate solution was added to the isopropanol using a syringe pump. In a second experiment the two liquids were interchanged so that isopropanol was added to the alginate solution in the beaker using a syringe pump. In both cases alginate precipitated in the form of fibres with varying diameters observed to be 0.1 mm to 1.0 mm and lengths of 1 cm or more.

### Example 5 Precipitation by pH Change

Three commercially available grades of chitosan were examined to determine molecular weight and degree of acetylation. Molecular weight was determined from intrinsic viscosity (η) measurements made using a Contraves Low Shear 30 instrument at 25 C and also from gel permeation chromatography using a high performance liquid chromatograph with a refractive index detector. Degree of acetylation was determined from the size of individual peaks observed by proton nuclear magnetic resonance at 500 MHz in a D₂O and DCl mixture as solvent. The observed properties were:

| | Intrinsic | | Molecular | |
|---|---|---|---|---|
| | viscosity [η] | Molecular | weight | |
| | (dL · g⁻¹) | weight from [η] | from GPC | DA (%) |
| Chitosan #1 | 4.0-4.1 | 81-84 × 10³ | 102 × 10³ | 16 |
| Chitosan #2 | 6.2-6.3 | 145-148 × 10³ | 184 × 10³ | 21 |
| Chitosan #3 | 9.7 | 262 × 10³ | 298 | 23 |

The values for degree of acetylation were similar and so the differing results in the following experiments were attributed to the variations in molecular weight.

Chitosan of each of the above grades was dissolved at a concentration of 1.5 wt % in 1 wt % acetic acid and then delivered from a syringe pump into a flowing 1.0 wt % sodium hydroxide solution which was stirred in a beaker with a central rotating cylinder as in FIG. 1. In each case, suspended bodies of the chitosan formed in the alkaline solution. The morphology of the suspended bodies was examining visually and with a stereomicroscope. It was observed that three distinct types of morphology were obtained.

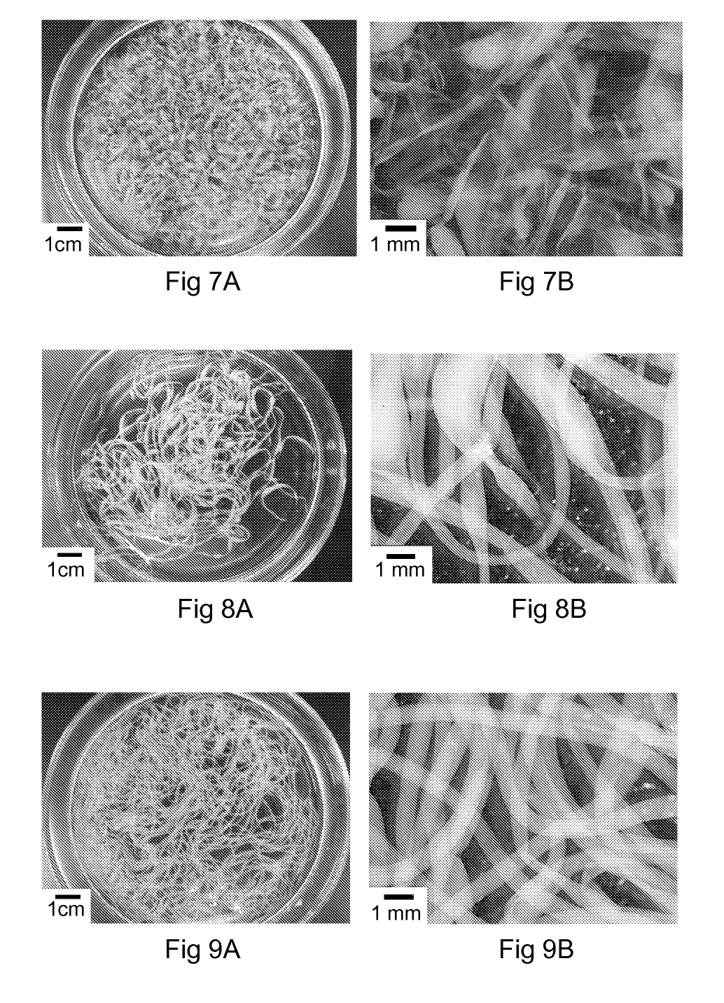

Chitosan #1 with the lowest molecular weight produced suspended bodies which were elongate in that their length exceeded their diameter or width, which was approximately 1 mm but the length was only 3 to 5 mm. These bodies are shown in FIGS. 7A and 7B.

Chitosan #2 with the intermediate molecular weight produced filaments of undulating, irregular diameter (head and tail configurations) such that a thick portion with a typical width of 1.5 mm was attached to a thinner portion. Length was 5 to 10 cm. These bodies are shown in FIGS. 8A and 8B.

Chitosan #3 with the highest molecular weight produced fibres of greater length, more than 10 cm, and regular diameter of 0.8-1.0 mm. These bodies are shown in FIGS. 9A and 9B.

The experiment was repeated using chitosan #3 (the highest molecular weight) at various concentrations. It was observed that similar morphologies to those above were obtained at different chitosan concentrations thus:

0.4-0.6 wt %: short, elongate bodies
0.7-1.2 wt %: undulating fibers of irregular diameter (head and tail configurations)
1.3-2.0 wt %: Continuous fiber with uniform diameter (0.8-1.0 mm)

It was found that these changes in morphology correlated with intrinsic viscosity of the chitosan solution, so that a 1.5 wt % solution of chitosan #2 had similar intrinsic viscosity to a 1.1 wt % solution of the higher molecular chitosan #3 and both produced fibres of irregular diameter.

It was observed that increasing the shear rate of the flowing sodium hydroxide solution led to thinner fibres. The fibres also became thinner when the concentration of sodium hydroxide solution was increased, presumably because the raised concentration of sodium hydroxide accelerated the precipitation of chitosan.

### Example 6

A solution of chitosan (0.48 wt %) in 1% acetic acid was made by stirring the chitosan and acetic acid for 30 minutes at approximately 2000 rpm in a laboratory blender. Then hydrolyzed guar (0.36 wt %) was added to the chitosan solution in the blender and the mixture was stirred for an additional 30 minutes. The aqueous chitosan-guar solution was transferred to a beaker with a central cylinder as shown in FIG. 1. The cylinder was rotated at 1000 rpm by an overhead motor, so that the solution between the rotating cylinder and stationary beaker wall was made to flow and subjected to shear. While stirring in this way, a 30% NaOH solution was added via syringe to reach a final concentration of 1 wt % NaOH. The mixture was stirred for a further 2 minutes at 1000 rpm (submitting the fluid to shear rates between 150 to 3005⁻¹) after addition of NaOH. A suspension of elongate bodies of fibrous appearance with uniform diameter of about 1 mm and length seen to be at least 2 cm and possibly more was formed. Analysis of the liquid phase showed a lower concentration of guar than the concentration before coalescence of polymer, indicating that the precipitation of chitosan had induced precipitation of guar jointly with the chitosan.

The ability of these fibre-like bodies to aid suspension of proppant particles was tested. In the test, 48 gm of ceramic proppant particles of size range such that 90% of the particles were of size between 600 and 850 micrometres, and having specific gravity of 2.7 were added to 100 ml of the suspension and mixed by hand to disperse the proppant particles. The resulting dispersion was placed in a measuring cylinder and the height of the bed of proppant particles was observed over time.

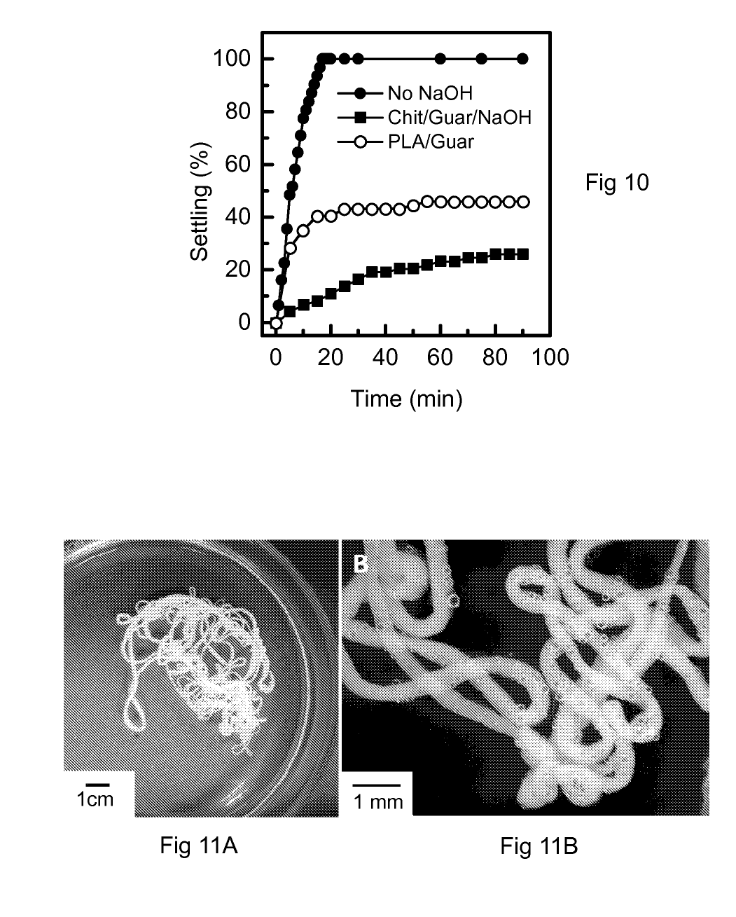

As comparisons this experiment was also carried out using (i) 100 ml of similarly prepared chitosan guar solution without addition of sodium hydroxide, and (ii) 100 ml of an aqueous suspension containing 0.48 wt % polylactic acid fibres and 0.36 wt % guar. The results are shown as FIG. 10 in which settling of the bed of proppant particles is expressed as a percentage of the distance from the original bed height to the final, fully settled, bed height. As can be seen, the least settling was observed with the suspended fibre-like bodies precipitated from the chitosan guar solution.

### Example 7 Reduction of Ionic Concentration

A gel solution of poly 2-hydroxyethylmethacrylate (polyHEMA) was obtained through a free radical polymerization of 2-hydroxyethylmethacrylate in heavy brine. 5.0 grams of 2-hydroxyethylmethacrylate were added to 100 mL of 0.21 wt % ZnBr₂/CaBr₂ brine. Additionally, 0.1 gram of 2,2′-Azobis(2-methylpropionamidine) was added as an initiator, and followed by conditioning the sample at 65° C. (150° F.) in a water bath for 24 hours. This provided a viscous solution of the poly HEMA in the brine. The mixture was allowed to return to ambient temperature.

After the mixture was returned to ambient temperature, 150 mL of de-ionized water was placed in a plastic beaker provided with a rotatable central cylinder as in FIG. 1. While stirring the water by rotating the cylinder at 600 rpm (corresponding to shear rates between approximately 80 to 180 s⁻¹) using an overhead motor, 20 mL of the polyHEMA solution was injected into the water, using a syringe pump.

Fiber-like precipitates of variable length were generated by the rapid precipitation of the polymer while under shear.

### Example 8 Increase of Ionic Concentration

A solution of 4.0 wt. % polyvinyl alcohol (PVA) in deionized water was made by adding approximately 8.0 g of dry PVA powder to 200 mL of deionized water pre-heated to 60° C. while mixing with an overhead mixer for 1 hour. This solution was then directly injected using a 20 mL syringe into a beaker containing a salt solution of 0.5 M Na₂SO₄ while stirring with a central cylinder, as in FIG. 1, rotating at 600 rpm. Within a few seconds of addition, the polyvinyl alcohol coalesced into sticky fibres of variable diameter.

### Example 9 Temperature Change

A solution of hydroxypropyl cellulose (HPC) (1.0 wt %) was prepared by dissolving the polymer in deionized water while stirring the mixture for 60 minutes at approximately 1500 rpm in a laboratory blender. Separately, 50 mL of deionized water were added to a 250 mL beaker with a central cylinder as in FIG. 1. The water was heated to 70° C. using a water bath. While rotating the cylinder at 1000 rpm (submitting the fluid between the cylinder and the wall of the beaker to shear rates between 150 and 300 s⁻¹), 5 mL of the HPC solution was added to the beaker of hot water using a syringe. Mixing was stopped immediately after the addition of HPC. Long, white, fiber-like precipitates formed and are shown in FIGS. 11A and 11B. It was observed that the fiber-like precipitates can be manipulated and are stable while kept in water above about 50° C., but swell and eventually dissolve completely after allowing the mixture to cool to room temperature.

### Example 10 Cross Linking

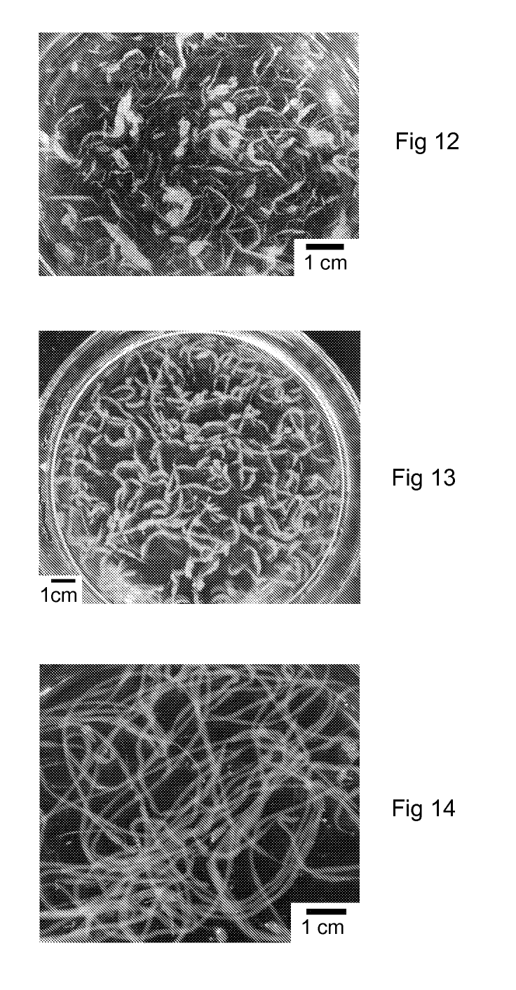

A 1.0 wt % aqueous solution of carboxymethyl cellulose (CMC) was made by mixing 2 gm CMC with 200 ml deionized water placed in a laboratory blender. 10 ml of 5 wt % aluminium chloride solution in water was then added from a syringe while continuing to mix. Suspended bodies of cross-linked CMC were formed as shown in FIG. 12. In a second experiment 0.5 wt % aqueous solution of CMC was added to 10 wt % aluminium chloride solution in water and the suspended bodies had a fibrous appearance as shown in FIG. 13. Fibrous suspended bodies were obtained similarly using diutan as the polymer instead of CMC.

### Example 11 Crosslinking with Nanoalumina

An aqueous solution of carboxymethyl cellulose (CMC) (0.5 wt %) was made by mixing CMC with water in a laboratory blender for 30-60 minutes until fully dispersed. A colloidal solution of nanoalumina particles (30 wt %) was then added to the polymer solution, at 0.5 vol %, resulting in a rapid crosslinking reaction. The shear provided (approximately 50-100 s⁻¹) by the blender induces formation of elongate suspended bodies with a diameter of approximately 1 mm.

A similar result was obtained using xanthan as the polymer in place of CMC.

### Example 12 Crosslinking

In this example, 20 mL of a solution of 1.0 wt. % carrageenan Iota in deionized water was injected, using a syringe, into a 150 mL solution of 5.0 wt. % CaCl₂.6H₂O in deionized water while continuously stirring with an overhead mixer running at 500 rpm and fitted with a 50 mm diameter 3 blade propeller. Carragenan crosslinked with calcium ions precipitated as filaments.

### Example 13 Crosslinking of Alginate

A 1.5 wt. % solution in deionized water of sodium alginate having a mean molecular weight of approximately 300 kilodaltons was injected into 150 mL of a 5.0 wt. % solution of CaCl₂.6H₂O in deionized water using the same procedure as in the previous example. Alginate, crosslinked with calcium ions, precipitated in the form of fibres of fairly uniform diameter between 0.5 and 1.5 mm and length greater than 10 cm, as shown in FIG. 14.

The above procedure was repeated using lower concentrations of alginate. It was found that continuous filaments of the alginate were produced when the alginate concentration was at least 0.3 wt % while above 1.1 wt % the filaments had uniform diameter.

The procedure was repeated again, using a stirring rate of 300 rpm, an alginate solution with concentration of 1.5 wt % and calcium chloride solutions of varying concentration. It was found that a calcium chloride concentration of at least 0.05 wt % was needed to induce precipitation. It was presumed that when this minimum concentration of the crosslinker was not present, the alginate became distributed in the stirred solution before cross linking occurred. Consistently with this, it was observed that as the concentration of calcium chloride was increased, the fibres formed by crosslinking of alginate became thinner. This was attributed to the speed of cross linking becoming faster, relative to the speed of diffusion, as calcium chloride concentration increased.

### Example 14, Incorporation of Other Solid

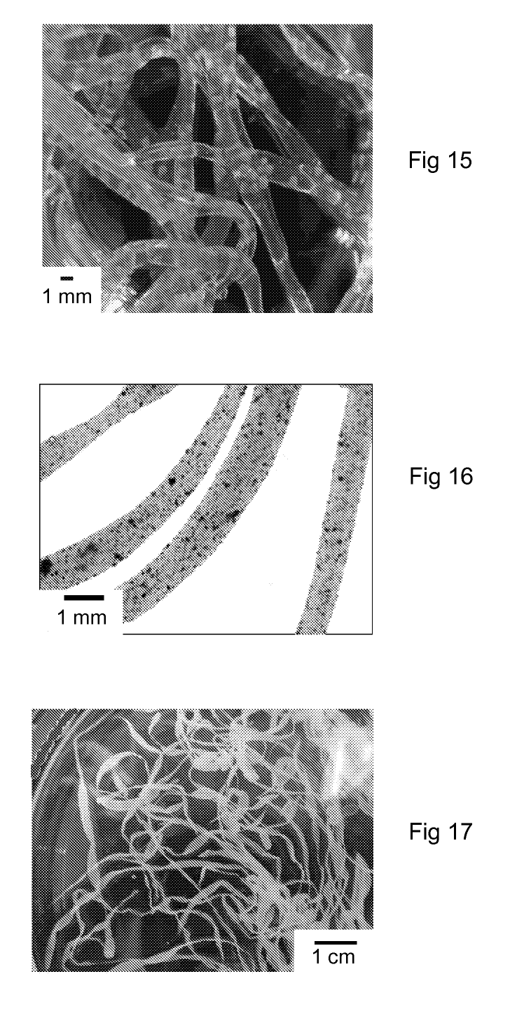

The formation of alginate fibres as in Example 13 above was carried out using an alginate solution containing suspended particles of an inorganic solid. The crosslinking by calcium ions produced suspended fibres, as in the previous example, but these had the inorganic solid particles trapped within them, as shown in FIG. 15.

Separately, fibres of chitosan#3 were made from a 1.5 wt % solution of chitosan as described in in Example 5 and shown by FIG. 4A with small particles of carbon (carbon nanotubes) dispersed in the chitosan solution. These particles became trapped within the fibres, as shown in FIG. 16.

### Example 15, Anionic Polymer Complex with Cationic Surfactant

A solution of carboxymethyl cellulose (CMC) was prepared by adding 2.5 g CMC powder to a blender containing 500 mL of water and blending for approximately 30 minutes at 1500 rpm. A 0.5 wt. % solution of the cationic surfactant alkyl (C12-16) dimethyl benzyl ammonium chloride (ADBAC) in water was prepared separately. The solution of CMC was placed in a beaker and stirred with a central cylinder as in FIG. 1. The ADBAC solution was then added, resulting in the immediate formation of white polymeric structures.

Particulate proppant was then added and mixed in. It was observed to remain in suspension in the flow. As the shear is stopped, the solid particles remain dispersed in the carrier fluid and settled more slowly than when mixed with water alone.

The formation of complexes of CMC and ADBAC was investigated by using varying proportions of the two materials. In a series of experiments, the concentration of CMC was kept constant while the amount of ADBAC was varied from 0.3 to 1.8 equivalents based on charge ratio. The aqueous polymer solutions were mixed vigorously in a blender for several minutes and then centrifuged to separate the precipitated complex from the supernatant solution.

The concentration of CMC (if any) in the supernatant was estimated from the viscosity of the supernatant. It was observed that when ADBAC was in an amount less than one equivalent based on charge ratio some CMC remained in the supernatant but when ADBAC was in excess of one equivalent based on charge ratio no CMC remained in the supernatant. This indicated that the complex which was formed had 1:1 stoichiometry, based on charge in the two materials. Collection and weighing of the precipitate showed that the weight of precipitate did increase slightly as the amount of excess ADBAC increased. This was attributed to some excess ADBAC being trapped in the precipitate as it formed.

### Example 16 Cationic Polymer Complex with Anionic Surfactant

A 0.5 wt. % solution of hydrated chitosan polymer was made by mixing 2.5 g of chitosan powder #3 (as used in Example 5) with 500 mL of 1.0 wt % acetic acid in a Waring blender at 1500 rpm for 30 minutes. In a separate beaker, the anionic surfactant sodium dodecyl sulfate (SDS) was dissolved in deionized water to form a 1.0 wt. % solution. The SDS solution was stirred using a central rotating cylinder as shown in FIG. 1. Some of the chitosan solution was added as a steady stream using a syringe pump. Ribbon-like polymeric structures were formed as shown in FIG. 17. These were observed to have widths of 1 to 5 mm and lengths exceeding 5 cm.

### Example 17 Complex Formation with Two Polymers

A 0.5 wt. % solution of hydrated chitosan polymer was made by mixing 2.5 g of chitosan powder #3 with 500 mL of 1.0 wt % acetic acid in a Waring blender at 1500 rpm for 30 minutes, as in the previous example. A 0.5 wt % solution of xanthan was made by mixing with deionized water in a Waring blender in the same way. Equal volumes of the two solutions were then combined under three different shear regimes, and in each case a complex of the two polymers precipitated.

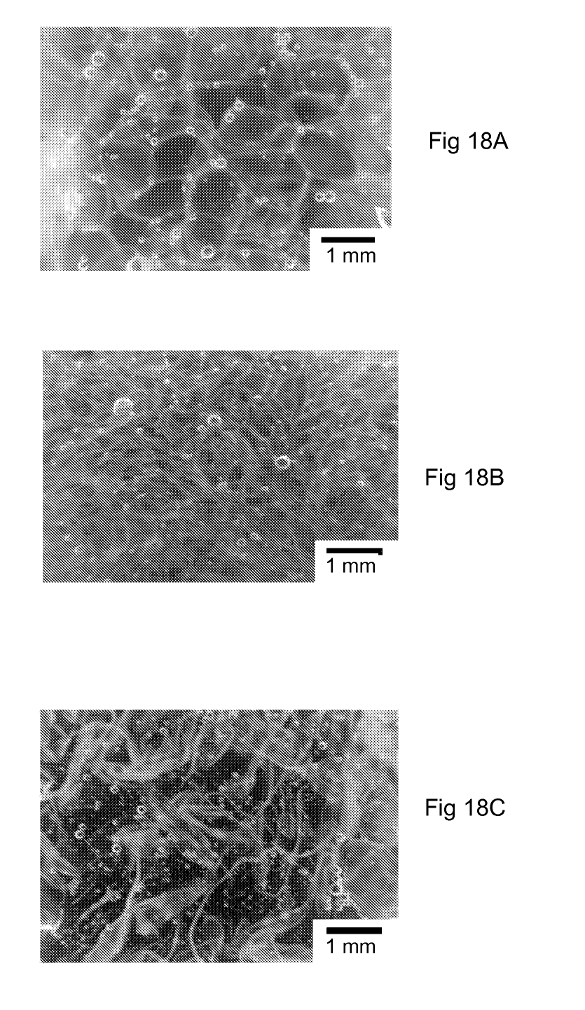

When mixing was carried out while stirring gently, large bodies of suspended polymer complex formed and a magnified view is shown in FIG. 18A. When mixing was carried out in the blender, while running it at a moderate speed the bodies of suspended polymer complex were smaller, as shown in FIG. 18B. When mixing was carried out in the blender, running at high speed the bodies of polymer complex were of fibrous and somewhat ribbon-like appearance as shown in FIG. 18C. Widths of 0.8 to 1.0 cm and lengths of 3 cm and above can be seen in this photograph.

The procedure of this example was repeated, with chitosan and xanthan both dissolved in 0.1M potassium chloride solution and then with them both dissolved in 0.27M potassium chloride solution. Mixing was carried out at high speed. Suspended bodies of polymer complex formed, but were more compact and the suspension had a greater quantity of free water.

The ability of the coalesced bodies of polymer complex to suspend particulate proppant was tested. A suspension of the coalesced polymer complex was mixed with particulate proppant and left to stand in a graduated measuring cylinder. It was observed that even when the suspensions contained 0.1M or 0.27M potassium chloride, the proppant had not completely settled even after 24 hours.

### Example 18 Complex Formation

A 0.5 wt. % solution of hydrated chitosan polymer was made as in the previous example. A 0.5 wt. % solution of carboxymethyl cellulose was mixing with deionized water in a Waring blender. The solutions were mixed in the blender while running it at high speed. Again a complex of the two polymers precipitated in a fibrous form from the mixed solution.

### Example 19

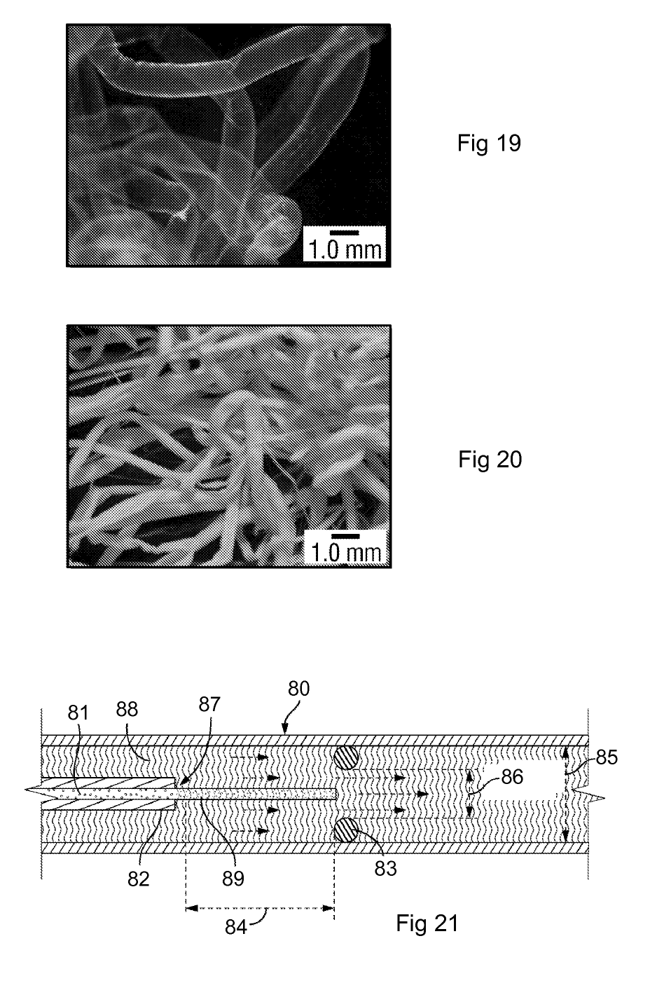

A 1.0 wt. % solution of alkyl dimethyl benzyl ammonium chloride (ADBAC) was made by diluting a concentrated solution of ADBAC in water and stirring. This solution was then circulated at 700 mL/min through the outer flow channel of a co-annular flow cell having a 1 cm by 1 cm square outer flow channel and a 1.0 mm ID inner pipe terminating within the flow cell. Separately a solution of 0.72 wt. % carboxymethyl cellulose (CMC) in deionized water was made by adding 0.72 g of CMC to 100 mL deionized water and mixing in a blender for 30 min. A dye solution was then added for visualization purposes. The dyed CMC solution was injected into the inner flow pipe of the flow cell at 5 mL/min flow rate. The two streams mixed and reacted within the flow cell to form elongated bodies having the appearance of fibres with a uniform diameter of approximately 1 mm and length of more than 2 cm, as shown in FIG. 19.

### Example 20

This example used the same materials as the previous example but the precipitation described in the previous example was inhibited by including a significant concentration of a salt.

A saline 0.72 wt. % carboxymethyl cellulose (CMC) solution was made by adding 0.72 g of CMC to 100 mL water and 5.0 wt. % potassium chloride (KCl) salt and mixing in a blender for 30 min. 4.6 mL of a 50% solution of alkyl dimethyl benzyl ammonium chloride (ADBAC) was then added. The polymer and surfactant remained in solution. Deionized water was then circulated through the square outer channel of the flow cell used in the previous example. The CMC/ADBAC/salt solution was injected into the inner flow pipe at 5 mL/min flow rate so that this solution mixed with deionized water in the flow cell. Elongate bodies were formed where this mixing took place, as the potassium chloride diffused into the fresh water. The elongate bodies of coalesced polymer had the appearance of long fibres, with diameters of approximately 0.5 to 1.0 mm and lengths of 2 cm or more as shown in FIG. 20.

### Example 21

A custom-built co-annular flow cell 80, as shown in FIG. 21, had an outer flow channel 85 provided by a 0.95 cm (⅜ inch) inner diameter (ID) clear acrylic tube. A 1.0 mm ID stainless steel tube 82 was centered within the channel. The end (exit) of the inner tube was positioned 8.5 cm into the 30 cm length of the flow cell. O-rings 83, reducing the effective diameter to a diameter 86 (for example 0.44 cm), were placed a predetermined distance 84 (for example 5 cm) downstream of the injection point 87 of the inner tube 82.

A 2.0% sodium alginate solution 81 was injected through the inner tube 82 using a high pressure ISCO syringe pump at 5.0 mL/min and emerged at the injection point 87 into the outer pipe. A solution 88 containing 5.0 wt. % CaCl₂.2H₂O was simultaneously pumped in the outer pipe via an impeller pump with variable controller (not shown). This process results in the polymer crosslinking shortly after contact with the calcium in the outer flow and coalescing in the form of a cylindrical fibre 89. Once the leading end of this fibre reaches the o-rings 83, the increased velocity accelerates the fibre causing it to break at its weakest point, which is at the injection point 87. During a continuous injection, this process of fibre formation and breakage is repeated at regular intervals resulting in the production of elongate fibres of a given length (e.g., 5 cm±0.5 cm).

### Example 22

Mechanical properties of coalesced bodies which were in the form of fibres were examined for comparison with commercially made dry fibres. Sample alginate fibres precipitated generally as in Example 13 at various shear rates and sample fibres of chitosan#3 precipitated as in Example 5 at various shear rates were taken out of suspension and their strength was tested using a TA instruments HDPlus Texture Analyzer. The tests were carried out at ambient temperature of 20° C. The fibre to be tested was held by clamps which were initially spaced 3 cm apart. The clamps were slowly moved further apart thereby applying force to the fibre, which was measured with a load cell until breakage occurred. The diameter of the fibre was measured on a photograph taken using a stereo microscope. The applied force and cross sectional area of the fibre were used to calculate applied force per unit area, which increased until breakage. Ultimate tensile strength is the force per unit area at breakage.

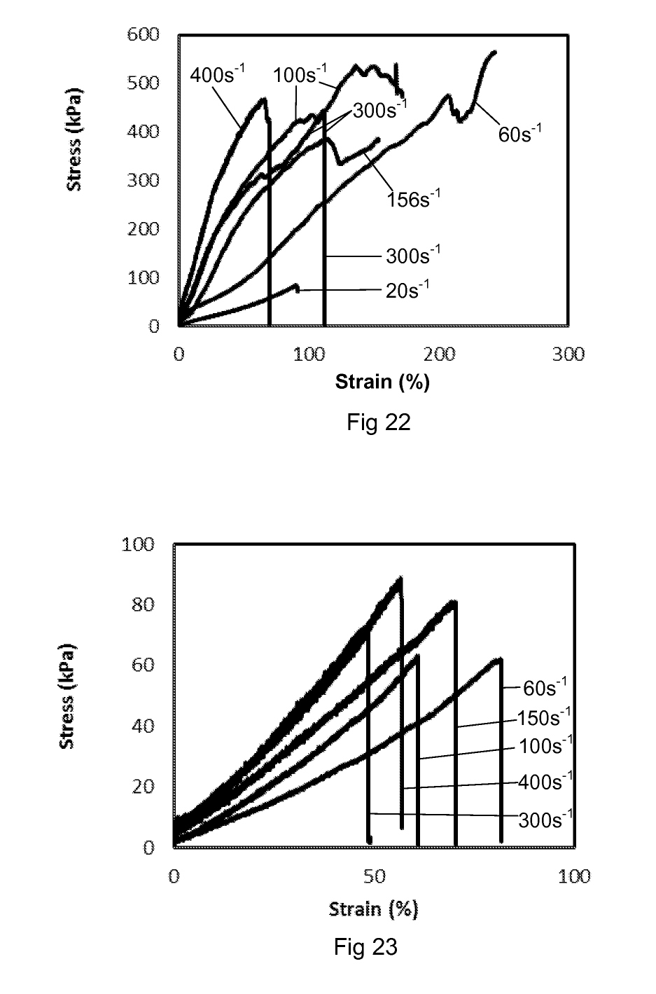

The extension of the fibres, i.e. strain in response to the applied force, was also measured. The results for these fibres, as plots of applied force per unit area (stress) and percentage extension (strain) up to breakage are shown in FIG. 22 for the alginate fibres and in FIG. 23 for the chitosan fibres.

Stress-strain curves of wet alginate fibers made at various shear rates are shown in FIG. 22. Most fibers tested exhibited tensile strength in the same order of magnitude (×10⁵ Pa). In contrast, as shown by FIG. 23, chitosan fibers made at various shear rates exhibited a narrower range of tensile strengths in the order of magnitude (×10⁴ Pa).

A relative trend was observed in terms of the effect of shear during fibre formation. In both cases, alginate and chitosan, increments in the initial slope of the stress-strain curve (Young's modulus) could be correlated with an increase in the amount of shear present during fibre production. This may be due to the alignment and stiffening of the polymer chains as they were subsequently precipitating or crosslinking.

It can be seen that there is some variation in the results from one fibre to another. However, when the same test was carried out on fibres which had been isolated and dried as part of their manufacture, it was found that they had an ultimate tensile strength about 100 times greater than that of the chitosan and alginate fibres referred to here.

The mechanical properties of fibres submerged in aqueous solution was tested using a DMA Q800 dynamic mechanical analyser available from TA Instruments. The fibre under test was kept submerged in aqueous solution and held between a fixed lower clamp and an upper clamp attached to the drive shaft of the test instrument. The instrument was operated to apply vibratory stress to the upper clamp and measure displacement. Storage modulus of the fibre under test was derived from the results.

For comparison, measurements were also made on polylactic acid fibre which is commercially available in dry form. Measurement was made on the dry fibre and on the fibre when submerged in deionised water. In both cases, the storage modulus was measured as approximately 6000 MPa at ambient temperature.

Measurements were made on alginate fibres made as in Example 13. The fibres were kept immersed in aqueous solution after they were formed so that they did not dry out. The storage modulus was found to be between 1.5 and 2 MPa at ambient temperature.

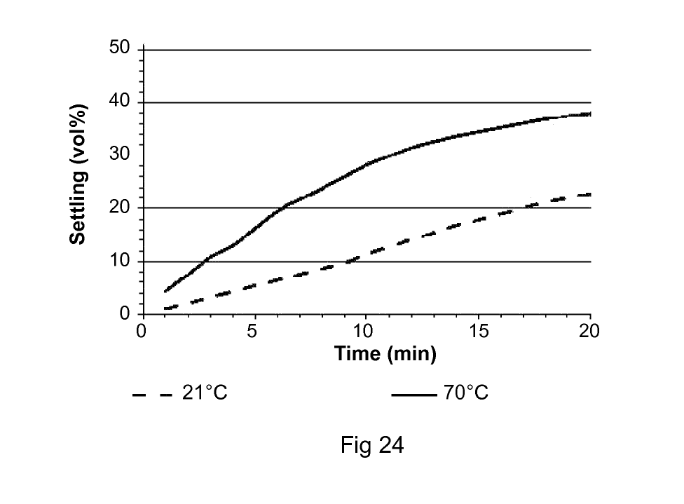

Although these alginate fibres were weaker than fibres of polylactic acid, the fibres have the ability to suspend proppant. A mixture of fibers and proppant particles was agitated vigorously, then poured into a measuring cylinder and allowed to stand. The height of the bed of proppant particles was observed over time. Measurement was made at ambient temperature and in a repeat experiment measurement was made in an oven at 70° C. The results are shown as FIG. 24 in which settling of the bed of proppant particles is expressed as a percentage of the distance from the original bed height to the final, fully settled, bed height.

### Example 23

A series of experiments to investigate the effect of shear rate was carried out using the apparatus of FIG. 1. The rotatable cylinder had a diameter of 4 cm and the gap between the cylinder and the side wall of the beaker was 1.2 cm. The rotational speed was controlled by a digital controller for the motor speed.

For each experiment, 50 ml of 5 wt % calcium chloride solution was placed in the beaker 10 ml of aqueous 1.5 wt % sodium alginate solution was injected into the calcium chloride solution. A similar series of experiments was carried out placing 1 wt % sodium hydroxide solution in the beaker and injecting a 2 wt % solution of chitosan.

Various rotational speeds were used. The shear rate at the mid-point of the gap between the cylinder and the side wall of the beaker was calculated using the following equation below:

$$\dot{γ} = \frac{2 ω {R}_{c}^{2} {R}_{b}^{2}}{{x}^{2} ( {R}_{c}^{2} - {R}_{b}^{2} )}$$

where:
ω=angular velocity of cylinder

$$( rad \text{/} s ) = ( \frac{2 π}{60} ) N$$

where N=rpm
R_{c}=radius of container (cm), in this case 3.2 cm
R_{b}=radius of the cylinder (cm) in this case 2 cm
x=radius at which shear rate is being calculated (cm) in this case 2.6 cm.

It was observed that alginate formed elongated wavy polymeric structures at low shear rates, (˜20 s⁻¹). In contrast, polymeric bodies in the form of fibers of uniform diameter were obtained at shear rates of about 60 s⁻¹ or above. As shown in the table below, the fiber diameter decreased as the shear rate was increased.

| | \dot{γ} at center of | Alginate fibers | Chitosan fibers |
|---|---|---|---|
| rpm | gap (s⁻¹) | diameter (mm) | diameter (mm) |
| 300 | 58.67 | 1.36 ± 0.15 | 1.32 ± 0.09 |
| 500 | 97.79 | 0.88 ± 0.12 | 1.05 ± 0.10 |
| 800 | 156.47 | 0.80 ± 0.08 | 0.80 ± 0.05 |
| 1000 | 195.59 | 0.75 ± 0.06 | 0.79 ± 0.04 |
| 1500 | 293.38 | 0.64 ± 0.11 | 0.84 ± 0.09 |
| 2000 | 391.17 | 0.46 ± 0.10 | 0.68 ± 0.04 |

### Example 24

Further experiments were carried out to investigate the effect of fluid motion. A co-annular flow cell similar to that in FIG. 21 although without o-ring 83 was used.

A 1 wt % solution of sodium alginate was prepared by mixing the polymer with deionized water while stirring the mixture 30 minutes at approximately 1500 rpm in a laboratory blender. The alginate solution was injected at a first flow rate (Qᵢ) along the inner pipe 82 of the flow cell. The outer channel 85 contained a 5 wt % solution of CaCl₂.2H₂O travelling at a different flow rate (Qₒ). Calcium alginate fibres were formed as the sodium alginate solution emerged from the inner pipe. The diameter of the resulting calcium-alginate fibers 89 decreased as the flow rate (Qₒ) of the calcium chloride solution in the outer channel 85 was increased, as shown in the table below.

| | \dot{γ} at interface | Fibers diameter using |
|---|---|---|
| Q₀ (mL/min) | (s⁻¹) | CaCl₂ (mm) |
| 350 | 16.00 | 0.97 ± 0.16 |
| 600 | 51.43 | 0.48 ± 0.09 |
| 750 | 72.68 | 0.45 ± 0.05 |
| 1050 | 115.19 | 0.39 ± 0.06 |
| 1310 | 152.04 | 0.36 ± 0.03 |
| 1700 | 207.30 | 0.43 ± 0.13 |

The above procedure was repeated with the variation that the outer channel of the flow cell contained a solution of 5 wt % CaCl₂.2H₂O plus 0.36 wt % guar in water. Results are set out in the table below. Once again the diameter of the resulting calcium-alginate fibers decreased as the flow rate in the outer channel was increased.

| Q₀ | \dot{γ} at interface | Fibers diameter using |
|---|---|---|
| (mL/min) | (s⁻¹) | CaCl₂/guar (mm) |
| 300 | 8.91 | 0.40 ± 0.08 |
| 450 | 30.17 | 0.38 ± 0.08 |
| 710 | 67.01 | 0.31 ± 0.03 |
| 900 | 93.94 | 0.26 ± 0.03 |

It will be appreciated that the example embodiments described in detail above can be modified and varied within the scope of the concepts which they exemplify. Features referred to above or shown in individual embodiments above may be used together in any combination as well as those which have been shown and described specifically. Accordingly, all such modifications are intended to be included within the scope of this disclosure as defined in the following claims.

1. A method of treating a downhole location within or accessed by a borehole, the method comprising:
coalescing polymer from a flowing aqueous polymer solution to generate an aqueous suspension of coalesced bodies of polymer, and
providing the aqueous suspension of coalesced bodies at the downhole location.

2. The method according to claim 1, wherein the coalesced polymer bodies are formed by coalescence of polymer at the surface and the aqueous suspension of bodies of polymer is delivered through at least one pump into the borehole, wherein the pump is configured to convey the aqueous suspension of bodies of polymer downhole.

3. The method according to claim 1, wherein the aqueous polymer solution is delivered through at least one pump into the borehole and the coalesced polymer bodies of polymer are formed by coalescence of the polymer underground.

4. The method according to claim 1, wherein the coalescing the polymer is brought about by crosslinking polymer molecules to form the coalesced polymer bodies in the aqueous suspension of bodies of polymer.

5. The method according to claim 1, wherein the polymer comprises an ionic charge and the coalescing the polymer is brought about by complexing with a material of opposite charge.

6. The method according to claim 1, wherein the coalescing the polymer is brought about by changing a parameter of the polymer solution selected from a group consisting of temperature of the solution, an ionic concentration of the solution, a pH of the solution and a solvent composition of the solution.

7. The method according to claim 1, wherein the coalescing the polymer comprises mixing the aqueous polymer solution with a second solution that is also an aqueous solution.

8. The method according to claim 1, wherein the aqueous polymer solution comprises suspended solid particles and the coalesced polymer bodies enclose at least some of the solid particles.

9. The method according to claim 1, wherein the coalesced bodies of polymer are elongate and comprise an aspect ratio of at least 3:1.

10. (canceled)

11. The method according to claim 1 wherein coalesced polymer bodies comprise at least one dimension of the order of at least 1 cm.

12. The method according to claim 1, wherein the polymer has a molecular weight of at least 5,000 Daltons.

13. The method according to claim 1, wherein the coalesced polymer bodies are present in the suspension in an amount of the order from about 0.1 to 10% by weight of the suspension.

14. The method according to claim 1, wherein the coalesced polymer bodies comprise a tensile strength not exceeding about 1000 kPa.

15. The method according to claim 1, wherein the aqueous suspension containing coalesced bodies of polymer comprises a treatment fluid selected from a group consisting of a fluid loss control pill, a water control treatment fluid, a scale inhibition treatment fluid, a fracturing fluid, a gravel packing fluid, a drilling fluid, and a drill-in fluid.

16. The method according to claim 15, wherein the treatment fluid comprises a fracturing fluid and further comprises a particulate proppant.

17. The method according to claim 15, wherein the method of treating a downhole location comprises a method of hydraulic fracturing of a subterranean formation and the method of hydraulic fracturing of the subterranean formation comprises injecting a treatment fluid into a subterranean formation adjacent to the borehole at a pressure sufficient to create a fracture comprising opposing faces in the subterranean formation, and wherein the fracturing fluid of claim 15 is injected through the borehole into the fracture.

18. The method according to claim 1 further comprising:
degrading the coalesced polymer bodies after providing them at the downhole location.

19. An aqueous suspension of bodies of a polymer obtained or obtainable by a method according to claim 1.

20. The method according to claim 1, wherein flow properties of the flowing aqueous polymer solution are controlled to produce structural properties of the coalesced polymer bodies.

21. The method according to claim 7, wherein the mixing of the aqueous polymer solution with the second solution is configured to provide structural properties of the coalesced polymer bodies.

22. The method according to claim 1, wherein coalescing the polymer from a flowing aqueous polymer solution to generate the aqueous suspension of coalesced bodies of polymer comprises flowing the aqueous polymer solution with or proximal to a material to produce coalesced polymer bodies that encapsulate some of the material.

23. The method according to claim 22, wherein the material comprises one of a solid or a fluid.

24. The method according to claim 1, wherein the coalesced polymer bodies are maintained in aqueous suspension from when the coalesced polymer bodies are formed in the flowing aqueous polymer solution until being provided at the downhole location.
